(19) United States
(12) Patent Application Publication
(10) Pub. No.: US 2005/0141583 A1
(43) Pub. Date: Jun. 30, 2005

(54) Method and device for coherence reduction

(76) Inventor: Torbjorn Sandstrom, Pixbo (SE)

Correspondence Address: HARNESS, DICKEY & PIERCE, P.L.C., P.O. BOX 8910, RESTON, VA, 20195, US

(21) Appl. No.: 11/061,931

(22) Filed: Feb. 22, 2005

Related U.S. Application Data
(63) Continuation of application No. PCT/SE03/01355, filed on Sep. 2, 2003.

(30) Foreign Application Priority Data
Sep. 2, 2002 (SE) 0202584-9

(51) Int. Cl. H01S 3/08

(52) U.S. Cl. 372/98; 372/26; 372/99

(57) ABSTRACT

A laser device may include at least two mirrors forming a resonant cavity for reflecting laser radiation. The laser device may further include a diffuser, which may equalize a coherence length and/divergence during a period of time.

### PRIORITY STATEMENT

This application is a continuation under 35 U.S.C. § 111(a) of PCT International Application No. PCT/SE2003/001355, which has an international filing date of Sep. 2, 2003, which designated the United States of America, and which claims priority under 35 U.S.C. § 119 of Swedish Patent Applicant No. 0202584-9, filed on Sep. 2, 2002, the entire contents of both of which are hereby incorporated by reference.

### TECHNICAL FIELD

The present invention relates to laser devices, methods for creating laser beams, lithography, and/or lithographic processes.

### BACKGROUND OF THE INVENTION

Excimer lasers use gases such as krypton, xenon, argon, neon, or the like, and a halide gas containing, for example, halide, F₂, and HCl, as active components. The active components and other gases may be contained in a discharge volume provided with laser optics at each end and longitudinally extending lasing electrodes, which may cause a transverse electrical discharge in the gases. Higher voltage pulses may be applied to the electrodes and may cause electrical pulse discharges to excite the gas atoms to a metastable state. This may cause an emission of photons, which may constitute a laser light.

Pulsed lasers with a higher M2 number, for example, excimer lasers may provide a time dependent divergence during the pulse. The light may become more coherent later in the pulse. For example, in pattern generation, metrology and/or inspection, a higher coherence at the end of the pulse may create speckle phenomena in an image.

FIG. 1 illustrates a conventional art transversally excited laser 100, for example, an excimer laser. The laser may include a mirror 110 and a mirror 120 forming a resonant cavity 170. The laser may further include an electrode 130 and an electrode 140, which may form a discharge volume 160. A housing 150 may enclose the discharge volume 160 and the resonant cavity 170. One of the mirrors 110 or 120 may be partially reflective for allowing a beam of radiation created within the resonant cavity to be emitted. The other mirror may be totally reflective. The housing 150 may be transparent for the emitted wavelength in an end where the partially reflective mirror may be arranged.

FIG. 2a illustrates an example first wave 180 of photons created within the conventional laser 100. The first wave 180 may be emitted from the laser with little or no internal reflection from the electrodes 130, 140 and/or the mirrors 110 and 120. The first wave of photons may be relatively divergent due to the fact that the radiation may be emitted at the end of the discharge volume, where the end may be close to the partially reflective mirror.

FIG. 2b illustrates an example second wave 182 of photons created within the conventional laser 100. Since this illustration includes elements similar to those in FIG. 2a, a detailed description of such elements will be omitted here for the sake of simplicity, by assigning the same reference numerals to the corresponding elements. The same applies to FIG. 2c. The second wave 182 may be emitted from the laser after being reflected, for example, once from the totally reflective mirror. The second wave of photons may be less divergent, or more coherent compared to the first wave of photons, because of geometrical truncation during the second pass through the electrode area.

FIG. 2c illustrates an example third wave 184 of photons created within the conventional laser 100. The third wave 184 may be emitted from the laser being reflected once at the partially reflective mirror and once at the totally reflective mirror. The third wave of photons may be less divergent than the second wave and less divergent than the first wave of photons.

FIG. 8 illustrates a conventional art hemispherical resonator 870, which may support a single transversal mode. The conventional resonator 870 may include curved mirrors 810 and 820. FIG. 9 illustrates a conventional resonator with curved mirrors 910 and 920, which may support multiple transversal nodes. The mirrors included in the resonating cavity of FIGS. 8 and 9 may differ in size. FIG. 10 illustrates a conventional resonating cavity 1070, which may include flat mirrors 1010 and 1020. Modes may be constrained, for example, by geometrical constraints of stops and/or electrodes.

### SUMMARY OF THE INVENTION

Example embodiments of the present invention provide a method and a device for modifying coherence properties of pulsed lasers.

An example embodiment of the present invention provides a laser, which may include at least two mirrors, and a diffuser. The mirrors may form a resonant cavity for reflecting laser radiation, and a region for performing stimulated emission. The diffuser within the resonant cavity may equalize a divergence of the laser radiation during a period of time.

Another example embodiment of the present invention provides a laser, which may include at least two mirrors. The mirrors may form a resonant cavity for reflecting laser radiation and a region for performing stimulated emission, and at least one of the mirrors may be adapted to equalize a divergence of the laser radiation during a period of time.

Another example embodiment of the present invention provides a laser, which may include at least two mirrors. The mirrors may form a resonant cavity for reflecting laser radiation and a region for performing stimulated emission, and at least one of the mirrors may be flat, or substantially flat, in a region in the vicinity of an optical axis of the laser. A peripheral part of the at least one mirror may be adapted to equalize a divergence of the laser radiation during a period of time.

Another example embodiment of the present invention provides a method for creating a laser beam. The example embodiment of the method may include forming a resonant cavity including at least two mirrors, forming a region within the resonant cavity for performing stimulated emission, providing lasing material into the region within the resonant cavity, and modifying the a coherence property of the laser beam using a diffuser within the resonant cavity.

In example embodiments of the present invention, the diffuser may provide a phase modulation of the laser radiation.

In example embodiments of the present invention, the diffuser may be integrated with at least one of the mirrors forming the resonant cavity.

In example embodiments of the present invention, at least one of the mirrors may be curved, spherical, or aspherical, and/or may have a reflective coating, which may be a multi-layer reflective coating.

In example embodiments of the present invention, a coherence property of the laser may be modified by the diffuser in at least one direction or at least two directions.

In example embodiments of the present invention, a diffuser may be provided in the flat, or substantially flat, region of the at least one of the mirrors, and may provide a laser with increased divergence.

In example embodiments of the present invention, the diffuser may be at least one of a separate semi-transparent plate arranged within the resonating cavity and may have a surface profile providing for phase modulation of the laser radiation.

In example embodiments of the present invention, laser radiation may be phase modulated by the diffuser.

In example embodiments of the present invention, the diffuser may be integrated with at least one of the mirrors forming the resonant cavity.

### BRIEF DESCRIPTION OF THE DRAWINGS

FIG. 1 illustrates a side view of a conventional excimer laser;

FIG. 2a illustrates an example first wave of photons in a conventional excimer laser pulse;

FIG. 2b illustrates an example second wave of photons in a conventional excimer laser pulse;

FIG. 2c illustrates an example third wave of photons in a conventional excimer laser pulse;

FIG. 3 illustrates a third wave of photons in an excimer laser including mirrors according to an example embodiment of the present invention;

FIG. 4a illustrates an example embodiment of a phase surface according to the present invention;

FIG. 4b illustrates another example embodiment of a phase surface according to the present invention;

FIG. 4c illustrates another example embodiment of a phase surface according to the present invention;

FIG. 4d illustrates another example embodiment of a phase surface according to the present invention;

FIG. 4e illustrates another example embodiment of a phase surface according to the present invention;

FIG. 5a illustrates an example embodiment of a method of creating a phase surface according to the present invention;

FIG. 5b illustrates another example embodiment of a method of creating a phase surface according to the present invention;

FIG. 5c illustrates another example embodiment of a method of creating a phase surface according to the present invention;

FIG. 5d illustrates another example embodiment of a method of creating a phase surface according to the present invention;

FIG. 6 illustrates another example embodiment of a phase surface arrangement according to the present invention;

FIGS. 7a-h illustrate examples of phase patterns according to example embodiments of the present invention;

FIG. 8 illustrates a conventional art stable hemispherical resonator;

FIG. 9 illustrates a conventional art stable resonator;

FIG. 10 illustrates a conventional art flat-flat resonator;

FIG. 11 illustrates an example embodiment of a resonator according to the present invention;

FIG. 12 illustrates another example embodiment of a resonator according to the present invention; and

FIG. 13 illustrates an example of the geometry of an example embodiment of the present invention.

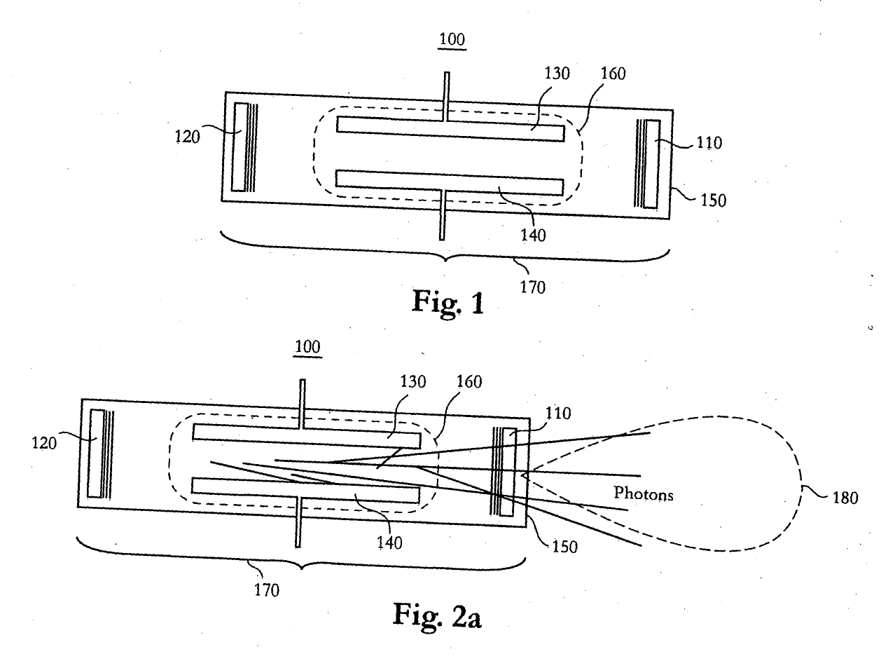

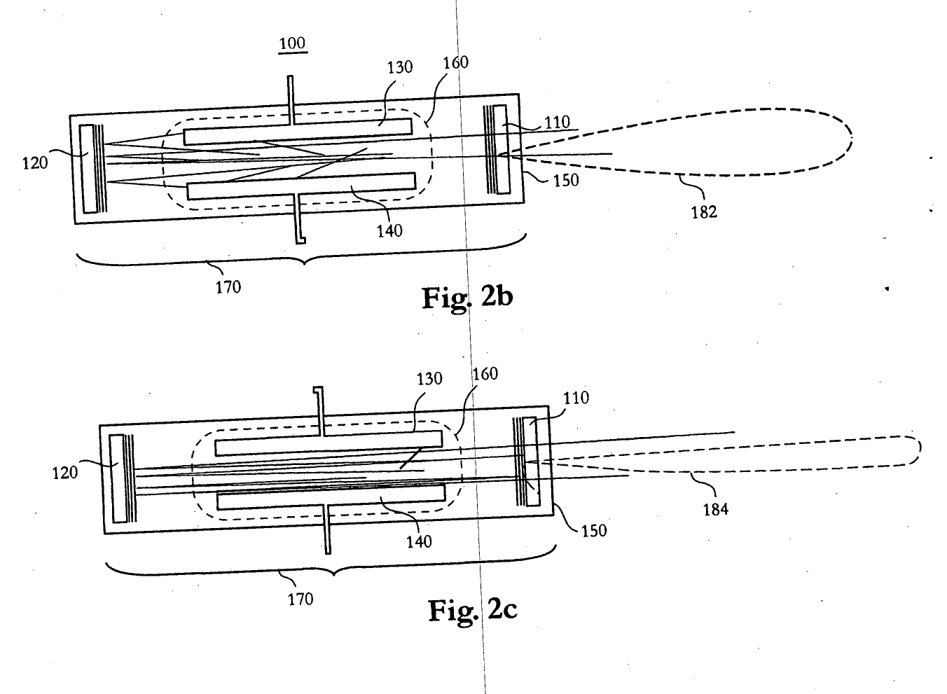

### DETAILED DESCRIPTION OF THE EXAMPLE EMBODIMENTS OF THE PRESENT INVENTION

The following detailed description of example embodiments of the present invention is made with reference to the figures. However, it will be understood that example embodiments of the present invention, as described herein, are described to illustrate the present invention, not to limit its scope, which is defined by the claims.

Example embodiments of the present invention have been described with respect to an excimer laser. However, it will be understood that other lasers may be used, for example, optically or electrically pumped gas, liquid or solid state lasers such as Nd:YAG-lasers, dye-lasers, copper-vapour-lasers, ruby lasers, garnet lasers, CO₂ lasers, free-electron lasers, Ti-sapphire lasers, semiconductor lasers, or the like.

Example embodiments of the present invention relate to a method for equalizing variations in coherence during a pulse, for example, during pulses in an excimer laser. An excimer laser may be useful when patterning a workpiece using, for example, a spatial light modulator (SLM).

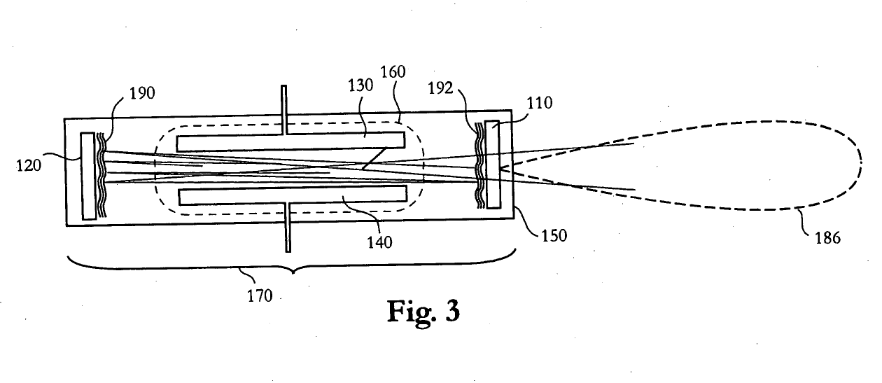

FIG. 3 illustrates an example embodiment of a device, which may create waves of photons having equalized divergence, according to the present invention. In FIG. 3, the electrodes 130 and 140, the housing 150, and the discharge volume 160 may be the same, or substantially the same, as in a conventional excimer laser. Mirrors 110 and 120 may form a resonant cavity 170 and may be provided with diffusers (e.g., diffusers) 190 and 192. The diffuser 190 and 192 may counteract a narrowing of the beam at the end of the pulse and may sustain a more constant radiation pattern regardless of the number of cycles or roundtrips. Both mirrors 110 and 120 may be have the diffusers 190 and 192, however, in example embodiments of the present invention, one or both of the mirrors 110 and 120 may have the diffuser. The diffusers 190 and 192 may be equal or unequal.

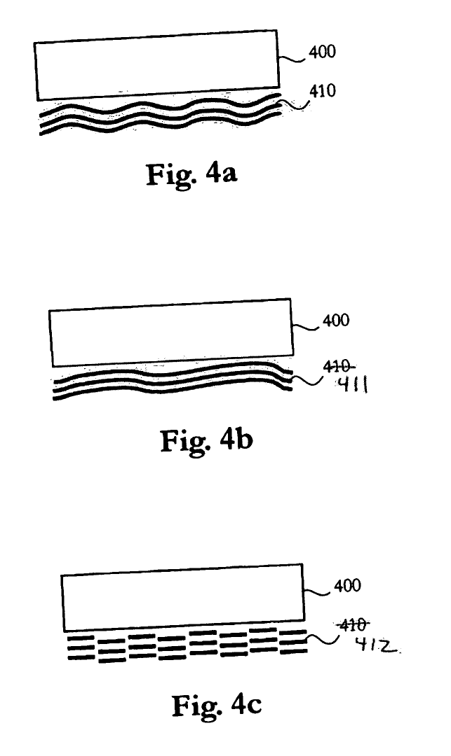

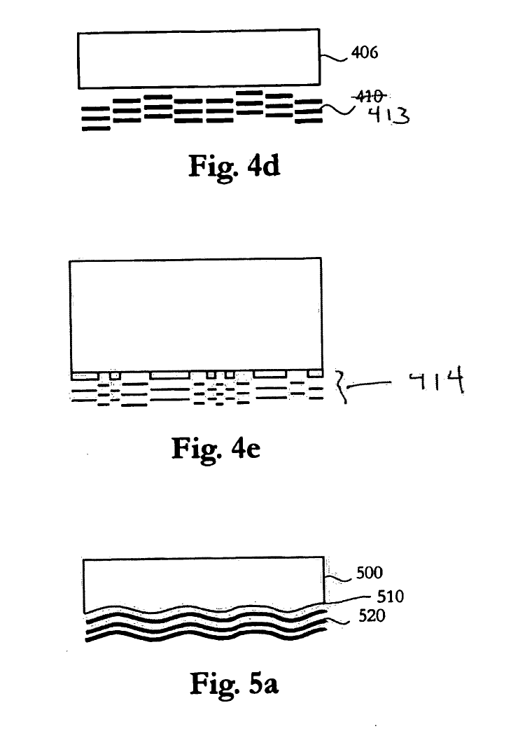

FIGS. 4a-4e illustrate examples of types of diffusers, which may be phase surfaces 410-414 having diffusing characteristics. The phase surfaces 410-414 may be provided on a substrate (e.g., flat substrate) 400, which may be a mirror or a separate plate.

FIG. 4a illustrates a periodic or non-periodic grating 410, which may be continuous and/or 1-dimensional or 2-dimensional.

FIG. 4b illustrates an example phase surface, which may be continuous and/or have a spherical or an aspherical surface 411. The continuous and/or spherical or aspherical surface may diffuse the light. The aspherical surface may be rotationally symmetric, and may have different symmetry in, for example, two orthogonal directions. The aspherical surface may also be non-symmetric.

FIG. 4c illustrates an example phase surface, which may include flat portions 412. The flat portions may be arranged symmetrically or non-symmetrically. For example, flat portions 412 arranged adjacent to one another may have different phases throughout the surface. The flat portions 412 may also be randomly distributed over the surface. The phases may be, for example, two, three or more states. The states of the flat portions 412 may refer to a distance from a top surface of the flat portion to a virtual surface within or outside the mirror.

FIG. 4d illustrates an example kinoform surface 406. In example embodiments of the present invention, the kinoform surface 406 may include flat portions 413. The phase surfaces shown in FIGS. 4a-d may include a multi-layer reflective coating. The coherence properties of the laser may be modified, for example, by introducing a smaller amount of light scattering inside the resonator. Since the phase pattern and/or the depth of the pattern may more easily adjust the amount and/or angular characteristics of the scattering, the laser may be tailored to an application. In FIG. 4e the phase surfaces 414 may be arranged in an irregular pattern.

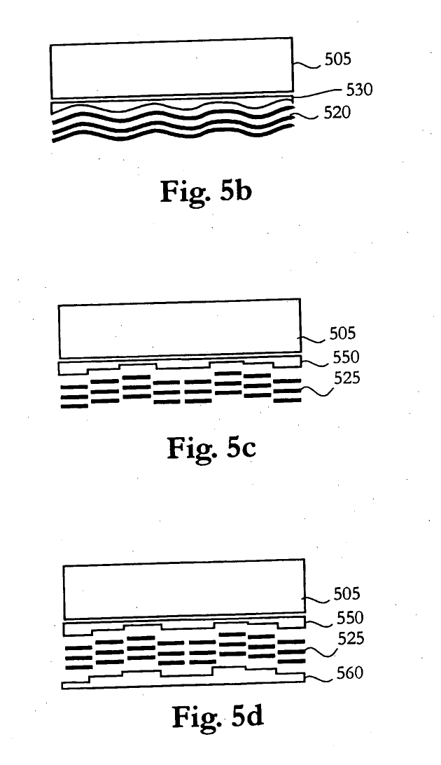

FIG. 5a-d illustrates an example embodiment of a method for creating the phase surface, according to the present invention. FIG. 5a illustrates a side view of a substrate 500, which may have a figured surface 510. On top of the figured surface 510 a reflective coating (e.g., multi-layer of reflective coating) 520 may be deposited. The figured surface 510 may be etched (e.g., ion etched) and/or polished to a desired shape. The multi-layer 520 may be created, for example, by evaporation of one or a plurality of different optical materials.

FIG. 5b illustrates a profiled layer 530, which may be deposited on top of a flat substrate 505. For example, a profiled layer 530 may be deposited on the substrate and the multi-layer coating 520 may be deposited on the profiled layer 530. The profiled layer 530 may be created, for example, by evaporation of a first layer through one or more (e.g., a sequence of) masks (e.g., mechanical masks).

FIG. 5c illustrates portions of flat surfaces 550, which may be evaporated and/or etched (e.g., plasma etched), for example, before depositing a multi-layer coating 525. FIG. 5d illustrates the multi-layer coating 525, which may be arranged with a coating 560, and may provide a flat top surface.

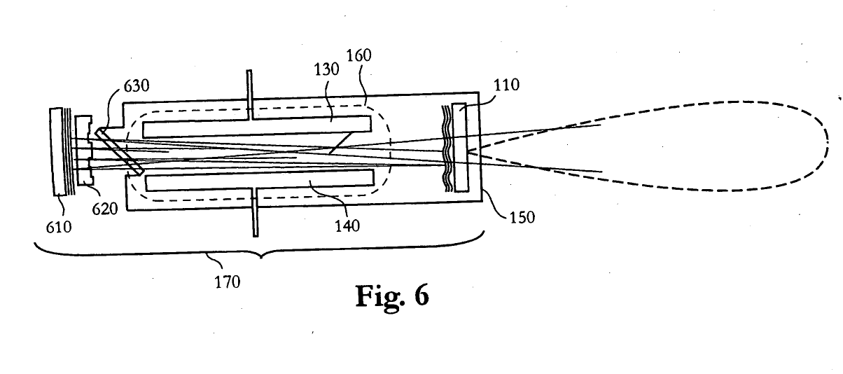

FIG. 6 illustrates another example embodiment of the present invention, in which one (or more) of the diffusing mirrors 110 and 120 may be replaced with a flat mirror 610 and/or a diffusing plate 620. A window (e.g., a Brewster window) 630, the mirror 610, and/or diffusing plate 620 may be outside the discharging volume 160. The discharging volume 130 may be the same, or substantially the same, as that illustrated in FIG. 3. The plate 620 and window 630 may be combined into the same component, for example, a Brewster window with a surface profile which may provide a phase modulation.

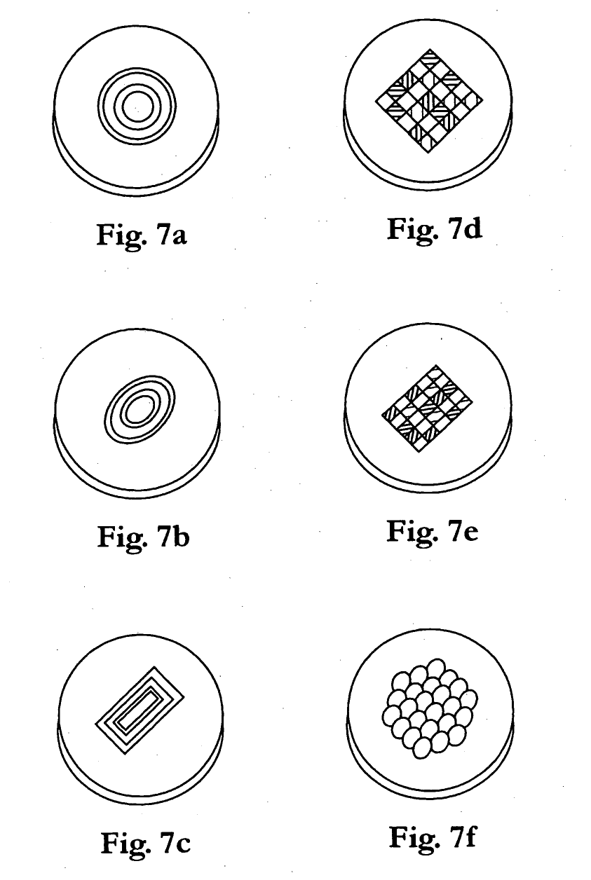

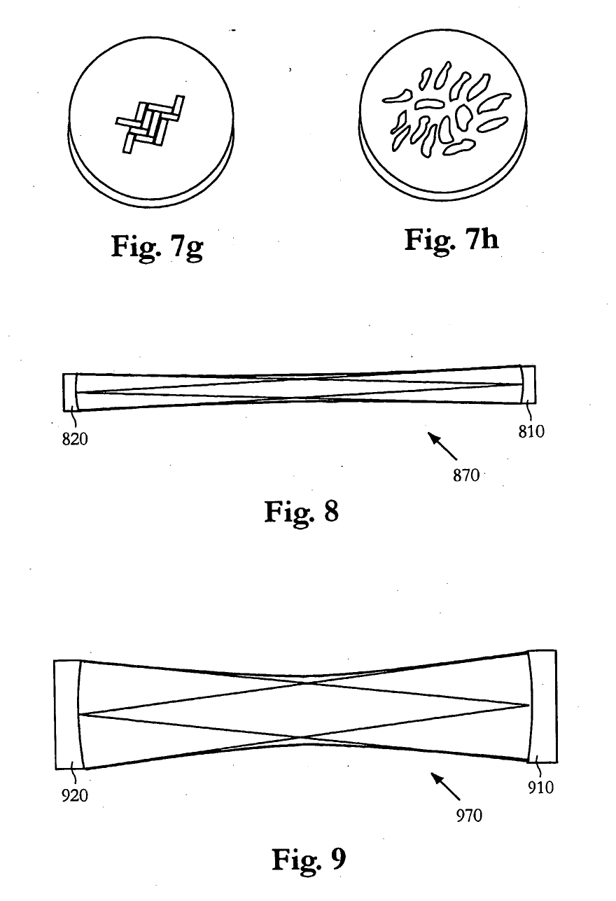

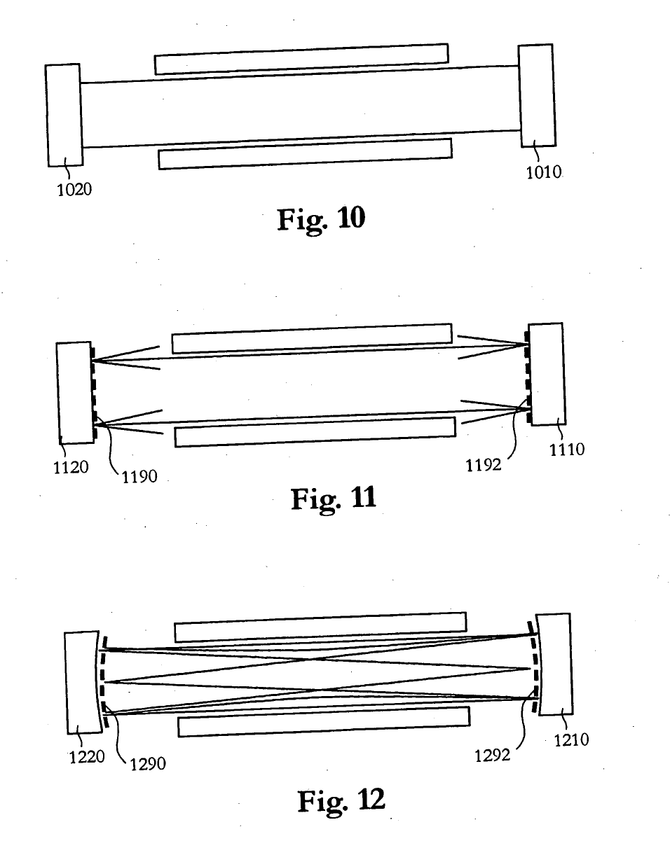

FIGS. 7a-7f illustrate top views of example embodiments of phase maps of the surfaces of the diffusing mirror and/or the diffusing plate.

FIG. 7a illustrates a circular symmetrical pattern, FIG. 7b illustrates an elliptical symmetrical pattern, FIG. 7c illustrates a rectangular symmetrical pattern, FIG. 7d illustrates a square shaped asymmetrical pattern, FIG. 7e illustrates a rectangular asymmetrical pattern and FIG. 7f illustrates a hexagonal pattern. A random pattern may be possible; for example, as illustrated in FIGS. 7g and/or 7h, however, a matrix representation may also describe the random patterns. One-dimensional gratings may also be used, for example, where coherence need be modified in one direction.

FIG. 11 illustrates a laser with scattering or diffusing mirrors according to an example embodiment of the invention. Mirrors (e.g., planar mirrors) 1110 and 1120 and a diffusing layer 1190 and 1192, which may be attached on top of the mirrors 1110 and 1120, may increase losses due to diffraction of part, or all, of the light outside an open area of the resonating cavity.

FIG. 12 illustrates another example embodiment of the present invention, in which the resonating cavity may be modified, for example, with curved mirrors 1210 and 1220 (shown, for example, as aspheric). The modified resonating cavity may direct light, which may have been scattered outside the resonating cavity with planar mirrors, into the cavity. The curved mirrors may be provided with a light scattering surface 1290 and 1292. The mirror curvature may improve extraction efficiency and/or increase divergence, for example, without a scattering surface.

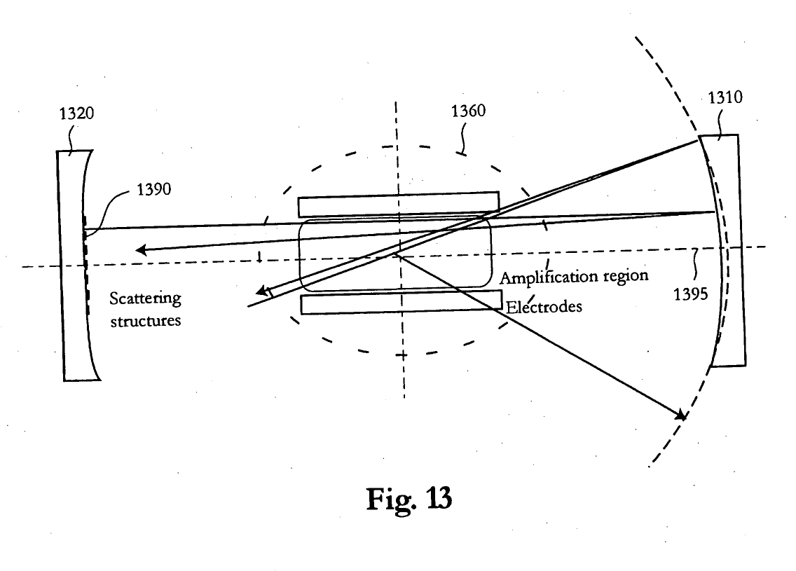

FIG. 13 illustrates another example embodiment according to the present invention. The resonator geometry may be designed for higher extraction efficiency and/or higher divergence. A peripheral part of the mirrors 1310 and 1320 in the resonator may be, for example, more spherical, while a center part, which may be closer to an optical axis 1395, may be flatter, or substantially flatter. In example embodiments of the present invention, the center curvature may be between flat and hemispherical and light scattering structures 1390 may be provided near the center of at least one mirror. More efficient extraction may allow the discharge region 1360 to be shorter. A shorter discharge volume may create a smaller laser with higher divergence.

Example embodiments of the present invention may provide a kinoform pattern, which may provide a controlled amount of light scattering, and/or a surface, which may have improved energy extraction and/or coherence.

In example embodiments of the present invention, the aspheric shape (e.g., FIG. 13) may improve extraction efficiency and/or increase divergence, and divergence may be improved, for example, by the diffusion of the mirrors. In example embodiments of the present invention, the aspheric curvature may be formed in the multi-layer coating on top of a flat substrate. In example embodiments of the present invention, the substrate may be aspheric, and may or may not have a diffusion layer. One or more of the mirrors may be aspheric, and may or may not have a diffusion coating. Alternatively, in example embodiments of the present invention, one or more of the mirrors may be flat, or substantially flat, and may or may not have a diffusion coating. In example embodiments of the present invention, a combination of aspheric mirrors, which may or may not have a diffusion coating, and flat, or substantially flat mirrors, which may or may not have a diffusion coating, may be used.

Although example embodiments of the present invention have been described with regard to ion etching and polishing, it will be understood that any suitable method for shaping a surface may be used.

Although example embodiments of the present invention have been described with respect to evaporation, it will be understood that any suitable method for creating a multi-layered surface may be used.

Although example embodiments of the present invention have been discussed as being useful when patterning a workpiece using, for example, a spatial light modulator (SLM), it will be understood that example embodiments of the present invention may be useful in other areas of lithography, and/or any area, which utilizes laser and/or laser pulses.

Although example embodiments of the present invention have been described with respect to certain diffusers (e.g., diffusing surfaces illustrated in FIGS. 4a-4e), it will be understood that any suitable diffuser or diffusing material may be used. Further, in example embodiments of the present invention, a diffuser may be, for example, a diffusing surface, a mirror, a plate or any other suitable structure or material.

Example embodiments of the present invention have been described with respect to example phase maps of the surfaces of the diffusing mirror and/or diffusing plate (e.g., FIGS. 7a-7f). However, it will be understood that example embodiments of the present invention may use any suitable phase map.

Example embodiments of the present invention have been described with respect to example phase surfaces (e.g., FIGS. 4a-4e). However, it will be understood that example embodiments of the present invention may use any suitable phase surface.

Although several example embodiments of the present invention have been described with respect to certain characteristics, it will be understood that these characteristics may be interchangeable and/or modifiable between example embodiments of the present invention.

While example embodiments of the present invention have been particularly shown and described, it will be understood by those skilled in the art that the foregoing and other changes in form and details may be made therein without departing from the spirit and scope of the invention which should be limited only by the scope of the appended claims. Thus, example embodiments of the present invention disclosed above are used in a generic and descriptive sense only and not for purposes of limitation.

1. A laser device comprising:
at least two mirrors forming a resonant cavity for reflecting radiation and a region for performing stimulated emission; and
a diffuser within the resonant cavity for equalizing a divergence of the radiation during a period of time.

2. The laser device of claim 1, wherein the diffuser provides a phase modulation of the radiation.

3. The laser device of claim 1, wherein the diffuser is integrated with at least one of the mirrors forming the resonant cavity.

4. The laser device of claim 1, wherein at least one of the mirrors is curved.

5. The laser device of claim 4, wherein the at least one curved mirror is spherical.

6. The laser device of claim 4, wherein the at least one curved mirror is aspherical.

7. The laser device of claim 1, wherein at least one of the mirrors includes a reflective coating.

8. The laser device of claim 1, wherein the reflective coating is a multilayer reflective coating.

9. The laser device of claim 1, wherein a coherence property of the radiation is modified by the diffuser in at least one direction.

10. The laser device of claim 1, wherein a coherence property of the radiation is modified by the diffuser in at least two directions.

11. A laser device comprising:
at least two mirrors forming a resonant cavity for reflecting radiation and a region for performing stimulated emission, wherein at least one of the mirrors is adapted to equalize a divergence of the radiation during a period of time.

12. The laser of claim 11, wherein at least one of the mirrors is aspherical.

13. A laser comprising:
at least two mirrors forming a resonant cavity for reflecting laser radiation and a region for performing stimulated emission, wherein at least one of the mirrors is substantially flat in a region in the vicinity of an optical axis of the laser and a peripheral part of the at least one mirror is adapted to equalize a divergence of the radiation during a period of time.

14. The laser of claim 13, wherein at least one of the mirrors is spherical.

15. The laser of claim 13, wherein a diffuser is provided in the substantially flat region of the at least one of the mirrors for creating a laser with increased divergence.

16. The laser of claim 1, wherein the diffuser is at least one of a separate semi-transparent plate arranged within the resonating cavity and having a surface profile providing for phase modulation of the radiation.

17. A method for creating a laser beam, the method comprising:
irradiating radiation into a region, within a resonant cavity including at least two mirrors, for performing stimulated emission; and
modifying the a coherence property of the radiation using a diffuser within the resonant cavity.

18. The method of claim 17, wherein the radiation is phase modulated by the diffuser.

19. The method of claim 17, wherein the diffuser is integrated with at least one of the mirrors forming the resonant cavity.

20. The method of claim 17, wherein the at least one mirror includes a reflective coating.

21. The method of claim 20, wherein the reflective coating is a multilayer reflective coating.

22. The method of claim 17, wherein the coherence property of the radiation is modified by the diffuser in one direction.

23. The method of claim 17, wherein the coherence property of the radiation is modified by the diffuser in two directions.

24. The method of claim 17, wherein at least one of the mirrors is curved.

25. The method of claim 17, wherein at least one of the mirrors is at least one of substantially flat in a region in the vicinity of an optical axis of the laser and sphere shaped.

26. The method of claim 17, wherein the diffuser is provided in a substantially flat region of at least one of the mirrors for creating a laser with increased divergence.

27. The method of claim 24, wherein the curved mirror is spherical.

28. The method of claim 24, wherein the curved mirror is aspherical.

29. A laser arrangement comprising:
at least two mirrors forming a resonant cavity for reflecting radiation and a region for performing stimulated emission, wherein at least one of the mirrors is adapted to equalize a divergence of laser radiation during a period of time;
at least two electrodes forming a discharge volume; and
a housing enclosing the discharge volume and the resonant cavity.

30. A laser device for performing the method of claim 17.

31. A laser arrangement including the laser device of claim 1.

32. A laser arrangement including the laser device of claim 11.

33. A laser arrangement including the laser device of claim 13.

34. A laser arrangement including the laser of claim 33.
